(19) United States
(12) Patent Application Publication
(10) Pub. No.: US 2022/0294043 A1
(43) Pub. Date: Sep. 15, 2022

(54) HOUSING FOR AN ENERGY STORAGE DEVICE OF A VEHICLE

(71) Applicants: Julius Aktas, Bietigheim-Bissingen (DE); Thomas Eichinger, Berglen (DE); Peter Geskes, Ostfildern (DE); Stefan Moedinger, Remseck a.N. (DE); Georg Votteler, Backnang (DE); Johannes Weinmann, Stuttgart (DE); Dietmar Wilhelm, Wiernsheim (DE)

(72) Inventors: Julius Aktas, Bietigheim-Bissingen (DE); Thomas Eichinger, Berglen (DE); Peter Geskes, Ostfildern (DE); Stefan Moedinger, Remseck a.N. (DE); Georg Votteler, Backnang (DE); Johannes Weinmann, Stuttgart (DE); Dietmar Wilhelm, Wiernsheim (DE)

(73) Assignee: Mahle International GmbH, Stuttgart (DE)

(21) Appl. No.: 17/692,162

(22) Filed: Mar. 10, 2022

(30) Foreign Application Priority Data
Mar. 12, 2021 (DE) 10 2021 202 428.9

(51) Int. Cl. H01M 10/613; H01M 10/625; H01M 10/6556; H01M 10/6568

(52) U.S. Cl. CPC H01M 10/613; H01M 10/625; H01M 10/6556; H01M 10/6568; H01M 2220/20; H01M 50/213

(57) ABSTRACT

A housing for an energy storage device of a vehicle may include a main housing and a temperature control plate. The main housing may form a housing interior for a plurality of energy storage cells of the energy storage device. A temperature control fluid may flow through the temperature control plate for the temperature control of the plurality of energy storage cells. The main housing and the temperature control plate may be configured such that the temperature control plate can be inserted into the housing interior in an insertion direction. In an inserted configuration, the temperature control plate may form a positive connection with the main housing which may prevent displacement of the temperature control plate in the main housing transversely to the insertion direction.

### CROSS-REFERENCE TO RELATED APPLICATION

This application claims priority to German Patent Application No. DE102021202428.9 filed on Mar. 12, 2021, the contents of which is hereby incorporated by reference in its entirety.

### TECHNICAL FIELD

The present invention relates to a housing for an energy storage device of a vehicle, an energy storage device comprising such a housing, a temperature control plate for such a housing and/or for such an energy storage device. Furthermore, the invention relates to a method for manufacturing such an energy storage device.

### BACKGROUND

Energy storage devices for vehicles, especially for vehicles with electric drive units, represent a core component in the electrification of individual passenger transport. These energy storage devices can be designed as a drive battery or traction battery that supplies an electric drive unit of the vehicle with sufficient electrical energy, which is converted into kinetic energy of the vehicle by the electric drive unit. In order to provide a sufficient amount of electrical energy, such energy storage devices comprise several energy storage cells formed separately from each other.

In order to increase the acceptance of electric vehicles among end customers, it is therefore necessary for the energy storage system, as a core component of electrified individual passenger transport, to become less expensive to manufacture.

The present invention is therefore concerned with the problem of providing an improved or at least one alternative embodiment of the components of the energy storage device or of the housing or of the energy storage device, which is improved in particular with respect to manufacturing costs.

### SUMMARY

According to the invention, this problem is solved by the objects of the independent claims. Advantageous embodiments are the subject of the dependent claims.

The present invention is based on the general idea of using a temperature control plate to increase the mechanical resistance and/or to increase the structural rigidity of the energy storage device.

The housing for an energy storage device of a vehicle according to the invention comprises a main housing, which forms a housing interior for accommodating a plurality of energy storage cells of the energy storage device. The main housing may be hollow cylindrical in shape and have a rectangular cross-sectional shape.

The housing includes a temperature control plate through which a temperature control fluid flows for the temperature control of a plurality of energy storage cells of the energy storage device. The temperature control fluid can be a temperature control liquid, in particular a cooling liquid The temperature control plate can be designed as a cooling plate for cooling the energy storage cells. The temperature control plate can be designed separately from the main housing. Both the main housing and the temperature control plate can each be made of a metallic material.

The temperature control plate can be inserted and/or slide into the housing interior. The main housing and the temperature control plate are designed in such a way that the temperature control plate can be inserted into the housing interior in an insertion direction and the inserted temperature control plate forms a positive connection with the main housing which prevents displacement of the inserted temperature control plate in the main housing transversely to the insertion direction. The temperature control plate can be inserted into the main housing like a drawer during the manufacture of the housing and/or the energy storage unit.

The temperature control plate can be inserted into the housing interior in such a way that it divides the housing interior into two equally sized partial housing interiors. This can also be referred to as the centered location of the temperature control plate within the main housing.

The temperature control plate can be inserted into the housing interior in such a way that it divides the housing interior into two equally sized partial housing interiors. This can also be referred to as the centered location of the temperature control plate within the main housing.

In a centered arrangement of the temperature control plate, energy storage cells may be arranged on the temperature control plate such that a portion of the energy storage cells are arranged in the first partial housing interior and another portion of the energy storage cells are arranged in the second partial housing interior.

If the temperature control plate is arranged off-center, a number of energy storage cells can be arranged in one partial enclosure interior, while battery electronics components can be arranged in the other partial enclosure interior.

Due to the form-fit connection to the main housing, the temperature control plate increases the mechanical resistance and/or the structural rigidity of the housing or energy storage unit, in particular with regard to crash/crush requirements, so that, for example, the wall thickness of the housing, in particular of the main housing, can be reduced. This allows manufacturing costs to be reduced by saving on materials and the overall weight of the energy storage device to be lowered.

In an advantageous further development of the solution according to the invention, it is provided that the temperature control plate forms a connection side and a deflection side spaced apart from the connection side, in particular opposite the connection side. The temperature control plate forms at least one fluid channel arrangement which has a forward channel and a return channel for guiding a temperature control fluid through the temperature control plate, wherein the forward channel and the return channel are spaced apart from one another and each pass completely through the temperature control plate from the connection side to the deflection side. The housing has a deflection cover arranged on the deflection side of the temperature control plate, wherein the temperature control plate on the deflection side and the deflection cover are formed in such a way that together they form a connecting channel for fluidic connection of the forward channel and the return channel of the at least one fluid channel arrangement. This allows line connections, in particular supply lines and return lines, for the temperature control fluid to be arranged on one side of the energy storage unit, resulting in a compact and space-saving design.

In an alternative further development of the solution according to the invention, on the other hand, it can be provided that the temperature control plate forms an inlet side and an outlet side spaced apart from the inlet side, in particular opposite the inlet side. The temperature control plate forms at least one fluid channel arrangement which has a forward channel and a return channel for guiding a temperature control fluid through the temperature control plate, wherein the forward channel and the return channel are spaced apart from one another and each pass completely through the temperature control plate from the connection side to the deflection side. The housing has a connection cover arranged on the inlet side or on the outlet side of the temperature control plate, wherein the temperature control plate and the connection cover are designed in such a way that together they form a connection channel for fluidically connecting the inlet channel and the outlet channel of the at least one fluid channel arrangement. This allows line connections, in particular supply lines and return lines, for the temperature control fluid to be arranged on two different sides of the energy storage unit, which can be advantageous for special installation situations.

In an advantageous further development of the solution according to the invention, it is provided that the temperature control plate has a plurality of fluid channel arrangements spaced apart from one another, wherein the temperature control plate and the deflection cover or the connection cover are designed such that together they each form a connecting channel for each fluid channel arrangement.

In this way, the temperature control plate provides a spatially uniform temperature control power, in particular cooling power, so that uniform temperature control, in particular cooling, of energy storage cells is possible.

In an advantageous further development of the solution according to the invention, it is provided that the temperature control plate is formed at least partially or in sections or completely as an extrusion profile, and/or the temperature control plate is formed at least partially or in sections or completely as a metallic extrusion profile, and/or that the at least one fluid channel arrangement or all fluid channel arrangements of the temperature control plate are formed as extrusion cavities. This enables cost-effective production of the temperature control plate.

In an advantageous further development of the solution according to the invention, it is provided that the housing has a feed device for feeding a temperature control fluid, in particular a temperature control liquid or cooling liquid, to the temperature control plate, and that the housing has a return device for returning a temperature control fluid, in particular a temperature control liquid or cooling liquid, from the temperature control plate, wherein the feed device and the return device are arranged on the connection side of the temperature control plate. The temperature control plate can be connected to a closed temperature control fluid circuit via the supply device and the return device or form part of the closed temperature control fluid circuit.

In an advantageous further development of the solution according to the invention, it is provided that the main housing forms two guide devices projecting at least partially into the housing interior, wherein the two guide devices each extend with respect to a longitudinal direction of the housing. The longitudinal direction of the housing can be aligned parallel to the insertion direction. The two guide devices are arranged at a distance from each other with respect to a transverse direction of the housing. The housing transverse direction is aligned perpendicularly and/or transversely to the housing longitudinal direction. The two guide devices each embrace a part of the inserted temperature control plate in such a way that the temperature control plate inserted into the interior of the housing forms a positive connection with the main housing, which prevents a displacement of the inserted temperature control plate along a direction transverse to the insertion direction. The guide devices allow for easy fabrication of the housing, as the temperature control plate is simply inserted into the main housing to place it inside the main housing.

In an advantageous further development of the solution according to the invention, it is provided that the guide devices each form two longitudinal webs which project into the interior of the housing and are arranged at a distance from one another with respect to a upward direction of the housing, wherein the spacing of the longitudinal webs with respect to the vertical direction of the housing upward direction is adapted to the thickness of the temperature control plate. The housing upward direction is aligned transverse and/or perpendicular to the housing longitudinal direction and to the housing transverse direction, respectively.

In an advantageous further development of the solution according to the invention, it is provided that the main housing forms a stiffening web associated with each guide device on an outer surface facing away from the housing interior, wherein the respective stiffening web extends with respect to the longitudinal direction of the housing. In this case, the respective stiffening web is arranged between the two longitudinal webs of the guide devices associated to it with respect to the vertical direction of the housing. The associated stiffening webs further increase the structural strength and/or mechanical resistance of the housing.

In an advantageous further development of the solution according to the invention, it is provided that the temperature control plate forms at least one connecting groove on the deflection side, which extends from a forward channel to a return forward channel of at least one fluid channel arrangement, so that the temperature control plate together with the deflection cover forms a fluidic connection between the forward channel and the return forward channel on the deflection side. This allows the deflection cover to be formed with flat surfaces so that generous tolerance compensation is possible when positioning the deflection cover, thus reducing the manufacturing requirements of the deflection cover and lowering manufacturing costs.

In an advantageous further development of the solution according to the invention, it is provided that the temperature control plate forms at least one wedge-shaped recess. In the at least one wedge-shaped recess, a fixing wedge is provided which is formed separately from the main housing and separately from the temperature control plate and which rests partly against the temperature control plate and partly against the main housing, wherein the fixing wedge is connected to the main housing by a material bond.

The wedge-shaped recess of the temperature control plate can be formed on the deflection side of the temperature control plate. On the deflection side, the temperature control plate can form two wedge-shaped recesses which are spaced apart from one another in relation to the transverse direction of the housing and in each of which a fixing wedge is provided which is formed separately from the main housing and separately from the temperature control plate and which rests partly against the temperature control plate and partly against the main housing, wherein the fixing wedge is connected to the main housing by a material bond. The fixing wedges or fastening wedges can fix a battery module and/or temperature control plate, which is inserted into the main housing, by means of self-locking. The provided fixing wedges or fastening wedges can be pushed in at the same time (force-controlled) and then materially bonded to the main housing.

In an advantageous further development of the solution according to the invention, it is provided that at least one fixing wedge is arranged between two longitudinal webs of at least one guide device with respect to the upward direction of the housing.

Furthermore, the invention relates to an energy storage device for a vehicle, wherein the energy storage device comprises a housing according to the invention and a plurality of energy storage cells arranged in the interior of the housing, wherein the energy storage cells are arranged on the temperature control plate for temperature control.

The energy storage device may be a drive battery or traction battery and/or a drive accumulator or traction accumulator, which supplies an electric drive unit of the vehicle with sufficient electric energy to be converted into kinetic energy of the vehicle by the electric drive unit.

The energy storage device includes several energy storage cells, all of which have the same body shape. Energy storage cells can be battery cells and/or accumulator cells that provide electrical energy.

The energy storage cells may be, for example, round cells or prismatic cells or pouch cells or cylindrical energy storage cells.

In a centered arrangement of the temperature control plate, energy storage cells may be arranged on the temperature control plate such that a portion of the energy storage cells are arranged in the first partial housing interior and another portion of the energy storage cells are arranged in the second partial housing interior. In other words, the energy storage cells may be housed in two stories.

If the temperature control plate is arranged off-center, a number of energy storage cells can be arranged in one partial enclosure interior, while battery electronics components can be arranged in the other partial enclosure interior.

It can be provided that further cooling devices are formed in addition to the temperature control plate. For example, inter-cell cooling may be formed between the energy storage cells, or a cooling device may be formed to cool the sides of the energy storage cells that are spaced opposite the temperature control plate, such as on the top of the battery cells.

Furthermore, the invention relates to a temperature control plate for a housing according to the invention and/or for an energy storage device according to the invention. The temperature control plate may have all of the features described previously and below, individually or in any combination. The temperature control plate forms a connection side and a deflection side spaced from the connection side.

Furthermore, the temperature control plate forms at least one fluid channel arrangement which has a forward channel and a return channel for guiding a temperature control fluid through the temperature control plate. The forward channel and the return channel are spaced apart from each other and each pass completely through the temperature control plate from the connection side to the deflection side. The temperature control plate is designed on the deflection side in such a way that, together with a deflection cover designed separately from the temperature control plate, a fluidic connection can be formed between the forward channel and the return channel on the deflection side.

In an advantageous further development of the solution according to the invention, it is provided that the temperature control plate is formed at least partially or in sections or completely as an extrusion profile, and/or the temperature control plate is formed at least partially or in sections or completely as a metallic extrusion profile, and/or that the at least one fluid channel arrangement or all fluid channel arrangements of the temperature control plate are formed as extrusion cavities. The fluid channel arrangements can all be aligned parallel to each other and/or parallel to a longitudinal plate direction or an extrusion direction.

Furthermore, the invention relates to a method for manufacturing an energy storage device according to the invention. In this method, a temperature control plate according to the invention is first provided, to which a plurality of energy storage cells of the energy storage device are subsequently fixed. The temperature control plate with the energy storage cells fixed to it is then inserted with respect to an insertion direction into a housing interior of a main housing of a housing according to the invention, so that the energy storage cells are positioned within the housing interior of the main housing and in which the temperature control plate is then fixed in position with respect to the insertion direction in such a way that displacement, in particular a relative displacement, of the temperature control plate with respect to the main housing is prevented.

The position of the temperature control plate in relation to the insertion direction can be fixed on the deflection side by means of fixing wedges which are simultaneously inserted into wedge-shaped recesses in the temperature control plate in such a way that they are in partial contact with the temperature control plate and in partial contact with the main housing, and the fixing wedges are then connected to the main housing by a material bond, in particular by welding. A front plate with temperature control fluid connections can be fixed to the connection side of the temperature control plate, which in turn is connected to the main housing by a material bond, in particular by welding or laser welding.

### BRIEF DESCRIPTION OF THE DRAWINGS

Further important features and advantages of the invention are apparent from the dependent claims, from the drawings, and from the associated figure description based on the drawings.

It is understood that the features mentioned above and those to be explained below can be used not only in the combination indicated in each case, but also in other combinations or on their own, without leaving the scope of the present invention.

Preferred embodiments of the invention are shown in the drawings and will be explained in more detail in the following description, wherein identical reference signs refer to identical or similar or functionally identical components.

Showing, each schematically

FIG. 1 a perspective view of a housing,

FIG. 2 a partial perspective view of a housing,

FIG. 3 a perspective view of a temperature control plate,

FIG. 4 a perspective view of a temperature control plate equipped with energy storage cells,

FIG. 5 perspective view of an energy storage device,

FIG. 6 sub-view of a housing,

FIG. 7 front view of a housing with a view of a deflection plate,

FIG. 8 a perspective view of a fixing wedge fixed in the housing.

### DETAILED DESCRIPTION

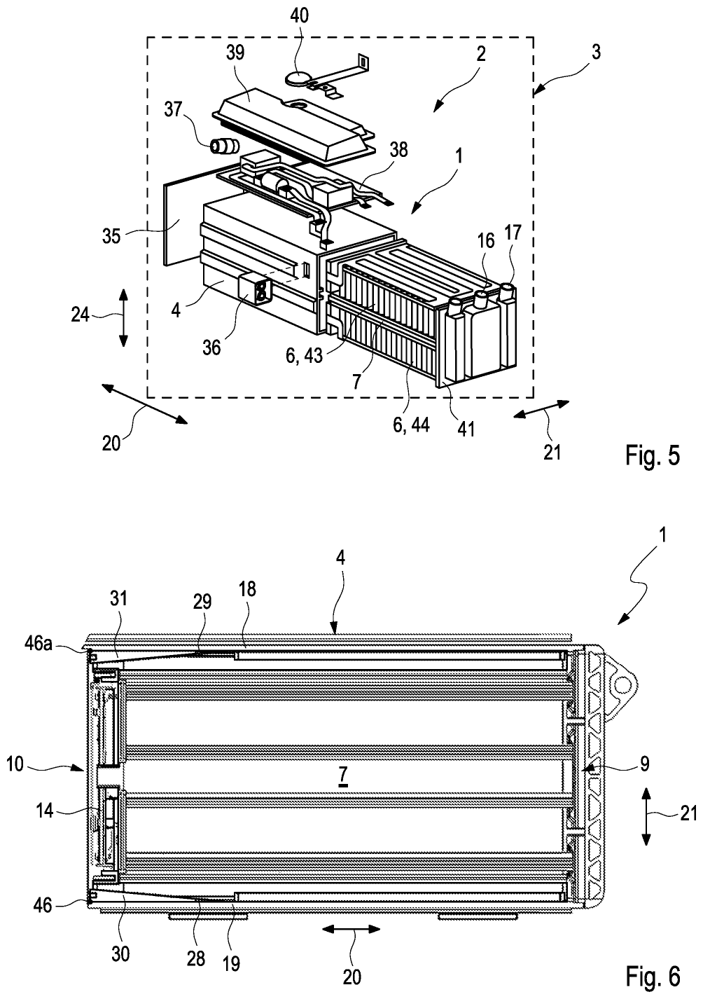

FIG. 1 shows a housing 1 for an energy storage device 2 of a vehicle 3, which is schematically indicated in FIG. 5. The housing 1 shown in FIG. 1 comprises a main housing 4, which forms a housing interior 5 for or to accommodate a plurality of energy storage cells 6 of the energy storage device 2. The housing 1 includes a temperature control plate 7 through which a temperature control fluid flows for the temperature control of a plurality of energy storage cells 6 of the energy storage device 2. The temperature control plate 7 is inserted into the housing interior 5 with respect to an insertion direction 8, wherein in FIG. 1 the temperature control plate 7 is not yet fully inserted. The temperature control plate 7, which is fully inserted into the housing interior 4, divides the housing interior 5 into two partial housing interiors 5a and 5b of equal or different size.

The main housing 4 and the temperature control plate 6 are designed in such a way that the temperature control plate 7 inserted into the housing interior 5 forms a positive connection with the main housing 4, which prevents displacement of the inserted temperature control plate 7 along a direction transverse to the insertion direction 8.

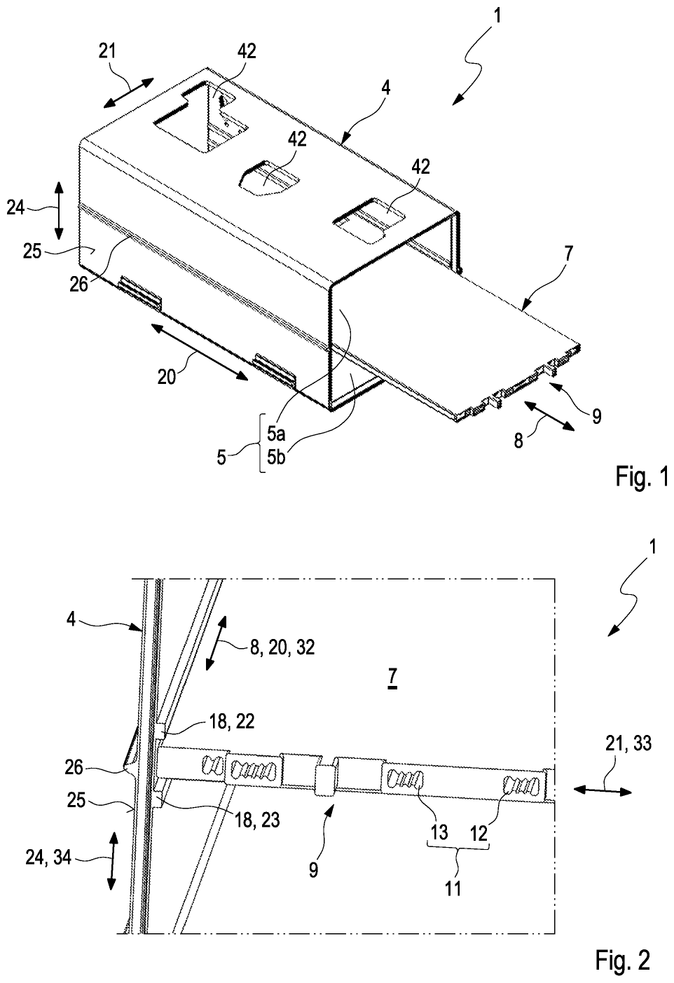

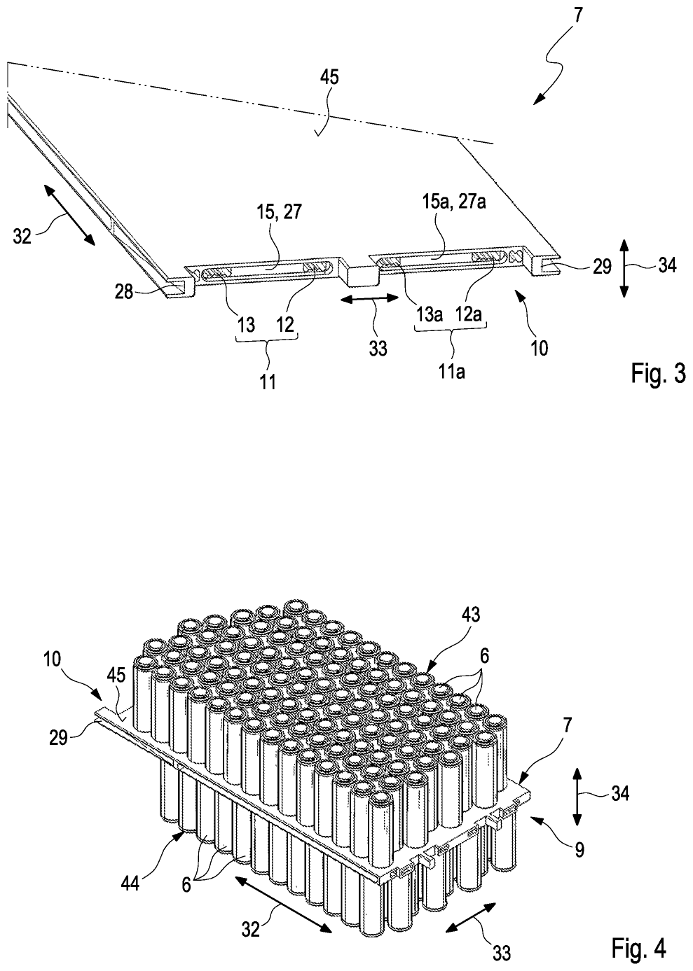

The temperature control plate 7 forms a connection side 9 and a deflection side 10 spaced from the connection side 9 with respect to a longitudinal direction of the plate 32. An enlarged view of the connection side 9 is shown in FIG. 2, while the deflection side 10 can be seen particularly well in FIG. 3.

In addition to a longitudinal plate direction 32, the temperature control plate 7 also has a plate transverse direction 33 and a plate upward direction 34, wherein the plate longitudinal direction 32, the plate transverse direction 33 and a plate upward direction 34 are aligned perpendicularly and/or transversely to each other, respectively.

When the temperature control plate 7 is inserted in the main housing 4, the plate longitudinal direction 32 is aligned parallel to the insertion direction 8.

The housing 1 has a housing longitudinal direction 20, a housing transverse direction 21 and a housing upward direction 24, wherein the housing longitudinal direction 20, the housing transverse direction 21 and a housing upward direction 24 are each aligned perpendicularly and/or transversely to one another. Housing longitudinal direction 20 is aligned parallel to insertion direction 8.

When the temperature control plate 7 is inserted in the main housing 4, the plate longitudinal direction 32 is aligned parallel to the housing longitudinal direction 20. When the temperature control plate 7 is inserted in the main housing 4, the plate transverse direction 33 is aligned parallel to the housing transverse direction 21. When the temperature control plate 7 is inserted in the main housing 4, the plate upward direction 34 is aligned parallel to the housing upward direction 24.

The thickness of the temperature control plate 7 can be determined with respect to the plate upward direction 34 and/or with respect to the housing upward direction 24.

As indicated in FIGS. 2 and 3, the temperature control plate 7 forms a plurality of one fluid channel arrangements 11 and 11a, each having a forward channel 12 and 12a, respectively, and a return channel 13 and 13a, respectively, for guiding a temperature control fluid through the temperature control plate 7, wherein the forward channel 12 and the return channel 13 are spaced apart from one another and each completely pass the temperature control plate 7 from the connection side 9 to the deflection side 10. The fluid channel arrangements 11 and 1 la extend with respect to the plate longitudinal direction 32 and are spaced apart with respect to the plate transverse direction 33.

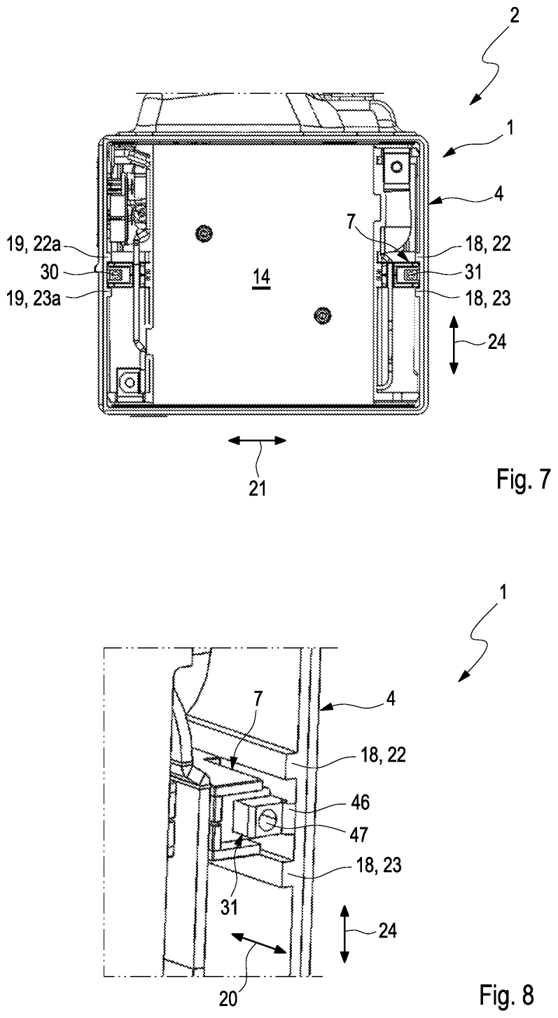

The housing 1 has a deflection cover 14, shown for example in FIGS. 6 and 7, which is arranged on the deflection side 10 of the temperature control plate 7. The temperature control plate 7 on the deflection side 10 and the deflection cover 14 are formed so that together they form a connecting channel 15 for fluidic connection of the supply channel 12 and the return channel 13 of the at least one fluid channel arrangement 11.

For this purpose, the temperature control plate 7 can form at least one connecting groove 27 on the deflection side 10, which extends with respect to the plate transverse direction 33 from a forward channel 12 to a return forward channel 13 of at least one fluid channel arrangement 11, so that the temperature control plate 1 together with the deflection cover 14 forms a fluidic connection between the forward channel 12 and the return forward channel 13 on the deflection side 10.

In FIG. 3, it is readily apparent that the temperature control plate 7 on the deflecting side 4 and the deflecting cover 14 are formed so that together they each form a connecting channel 15, 15a for each fluid channel arrangement 11, 11a. Here, for example, two corresponding connecting grooves 27, 27a are formed.

In FIGS. 6 and 7, it is readily apparent that the main housing 4 forms two guide devices 18, 19 projecting at least partially into the housing interior 5, wherein the two guide devices 18, 19 each extend with respect to the longitudinal housing direction 20 of the housing 1 and wherein the two guide devices 18, 19 are arranged at a distance from one another with respect to the transverse housing direction 21 of the housing 1.

The two guide devices 18, 19 each embrace a part of the inserted temperature control plate 7 in such a way that the temperature control plate 7 inserted into the housing interior 5 forms a positive connection with the main housing 4, which prevents displacement of the inserted temperature control plate 7 along a direction transverse to the insertion direction 8. This gripping around the temperature control plate 7 is shown enlarged in FIG. 2 for the guide device 18.

The guide devices 18, 19 each form two longitudinal webs 22 (or 22a) and 23 (or 23a), which project into the housing interior 5 and are arranged spaced apart from one another with respect to the housing upward direction 24 of the housing 1, wherein the spacing of the longitudinal webs 22 (or 22a) and 22 (or 22a) with respect to the housing upward direction 24 is adapted to the thickness of the temperature control plate 7. This is exemplified for the guide device 18 shown enlarged in FIG. 2.

The main housing 4 may form a stiffening web 26 associated with each of the guide devices 18, 19 on an outer surface 25 facing away from the housing interior 5. The respective stiffening web 26 may extend with respect to the longitudinal direction 20 of the housing 1, wherein the respective stiffening web 26 may be arranged with respect to the vertical direction 24 of the housing between the two longitudinal webs 22, 23 (or 22a, 23a) of the guide devices 18, 19 associated to it.

The temperature control plate 7 has two wedge-shaped recesses 28 and 29, which can be seen in FIGS. 3, 6, 7 and 8. As shown in FIGS. 7 and 8, a fixing wedge 30 and 31, respectively formed separately from the main housing 4 and separately from the temperature control plate 7, is inserted in each of the wedge-shaped recesses 28, 29.

The fixing wedges 30 or 31 rest partly against the temperature control plate 7 and partly against the main housing 4 and are connected to the main housing 4 by a material bond. In FIG. 9, it is readily apparent that the fixing wedge 30 is secured to the main housing 4 by a material connection 46, in particular a weld seam. The fixing wedges 30 or 31 can each have a positioning hole 47 for positioning the respective fixing wedge.

In FIG. 8, it can be clearly seen that the fixing wedge 31 is arranged between two longitudinal webs 22, 23 of the guide device 18 with respect to the housing upward direction 24. In an analogous manner, the fixing wedge 30 is also arranged between two longitudinal webs 22a, 23a of the guide device 19, as indicated, for example, in FIG. 7.

FIG. 4 shows a temperature control plate 7 to which several energy storage cells 6 are attached. The temperature control plate 7 has a first contacting surface 45 and a second contacting surface opposite with respect to the plate upward direction 34 and not visible. The energy storage cells 6 may be arranged in contacting relationship with both the first contacting surface 45 and the second contacting surface. The energy storage cells 6 form a first energy storage stack 43 and a second energy storage stack 43, between which the temperature control plate 7 is arranged with respect to the plate upward direction 43.

In order to produce the energy storage device shown in FIG. 5, the temperature control plate 7 is inserted into a housing interior 5 of a main housing 4 with the energy storage cells 6 or with the energy storage stacks 43 and 44 fixed to it with respect to the insertion direction 8, so that the energy storage cells 6 are positioned within the housing interior 5 and in which the temperature control plate 7 is then fixed in position with respect to the insertion direction 8 in such a way that displacement of the temperature control plate 7 with respect to the main housing 4 is prevented.

The housing 1 has a supply device 16 for supplying a temperature control fluid to the temperature control plate 7. The housing 1 has a return device 17 for returning a temperature control fluid from the temperature control plate 7. The supply device 16 and the return device 17 may be formed by a front plate 41 arranged on the connection side (4) of the temperature control plate (7) having temperature control fluid connections.

FIG. 5 schematically shows a vehicle 3 that has an energy storage device 2. The energy storage device 2 comprises the main housing 4, into which the temperature control plate 7 with energy storage cells 6 fixed to it can be inserted like a drawer.

The main housing 28 can be closed at one end with an end plate 35, whereas the end of the main housing 4 opposite this end can be closed by the front plate 41 with temperature control fluid connections. A supply of and/or flow through the temperature control plate 7 can be achieved via the temperature control fluid connections. The energy storage device 2 may have a high voltage terminal 36 and/or a low voltage terminal 37 and/or an energy storage management unit (or battery junction box) 38. A protective cover 39 may be formed to protect the energy storage management unit (or battery junction box) 36. The protective cover 39 may include a pressure equalizing element and/or bursting element 40. The low voltage terminal 37 may be fixed to the protective cover 39, while the high voltage terminal 36 may be located on the main housing 4.

The main housing 4 and/or the end plate 35 and/or the front plate 41 and/or protective cover 39 may be formed of a metallic material. These parts can be joined together by material bonding, in particular by laser welding and/or soldering. These parts can be formed, for example, by extrusion and/or stamping/bending.

To enable connection of the energy storage cells 2 to the energy storage management unit (or battery junction box) 36, the main housing 4 may include one or more apertures 42, shown for example in FIG. 1.

1. A housing for an energy storage device of a vehicle, comprising:
a main housing forming a housing interior for a plurality of energy storage cells of the energy storage device; and
a temperature control plate through which a temperature control fluid can flow for the temperature control of the plurality of energy storage cells;
wherein the main housing and the temperature control plate are configured such that the temperature control plate can be inserted into the housing interior in an insertion direction, and in an inserted configuration, the temperature control plate forms a positive connection with the main housing which prevents displacement of the temperature control plate in the main housing transversely to the insertion direction.

2. The housing according to claim 1, wherein:
the temperature control plate forms a connection side and a deflection side spaced from the connection side;
the temperature control plate forms at least one fluid channel arrangement that has a forward channel and a return channel for guiding the temperature control fluid through the temperature control plate;
the forward channel and the return channel are spaced apart from one another and each pass completely through the temperature control plate from the connection side to the deflection side;
the housing has a deflection cover arranged on the deflection side of the temperature control plate; and
the temperature control plate on the deflection side and the deflection cover are formed such that they form a connecting channel for fluidic connection of the forward channel and the return channel of the at least one fluid channel arrangement.

3. The housing according to claim 2, wherein:
the temperature control plate has a plurality of fluid channel arrangements spaced apart from one another; and
the temperature control plate on the deflection side and the deflection cover are configured such that together they each form a connecting channel for each fluid channel arrangement.

4. The housing according to claim 3, wherein:
the temperature control plate is formed at least partially or in sections or completely as an extrusion profile; and/or
the temperature control plate is formed at least partially or in sections or completely as a metallic extrusion profile; and/or
the at least one fluid channel arrangement or all fluid channel arrangements of the temperature control plate are formed as extrusion cavities.

5. The housing according to claim 2, wherein:
the housing has a feed device for feeding the temperature control fluid to the temperature control plate;
the housing has a return device for returning the temperature control fluid from the temperature control plate; and
the feed device and the return device are arranged on a connection side of the temperature control plate.

6. The housing according to claim 1, wherein:
the main housing forms two guide devices projecting at least partially into the housing interior;
wherein the two guide devices each extend with respect to a longitudinal housing direction of the housing;
the two guide devices are arranged at a distance from one another with respect to a transverse direction of the housing; and
the two guide devices each embrace a part of the inserted temperature control plate such that the temperature control plate inserted into the housing interior forms a positive connection with the main housing which prevents a displacement of the inserted temperature control plate along a direction transverse to the insertion direction.

7. The housing according to claim 6, wherein:
the guide devices each form two longitudinal webs which project into the housing interior and are arranged at a distance from one another with respect to a housing upward direction; and
a spacing of the longitudinal webs with respect to the housing upward direction is adapted to a thickness of the temperature control plate.

8. The housing according to claim 7, wherein:
the main housing forms a stiffening web associated with each guide device on an outer surface facing away from the housing interior;
the respective stiffening web extends with respect to the longitudinal direction of the housing; and
the respective stiffening web is arranged between the two longitudinal webs of the guide devices.

9. The housing according to claim 2,
wherein the temperature control plate forms at least one connecting groove on the deflection side, the connecting groove extends from a forward channel to a return channel of at least one fluid channel arrangement, so that the temperature control plate, together with the deflection cover, forms a fluidic connection between the forward channel and the return channel on the deflection side.

10. The housing according to claim 1, wherein:
the temperature control plate forms at least one wedge-shaped recess;
into the at least one wedge-shaped recess, a fixing wedge formed separately from the main housing and separately from the temperature control plate is introduced, which rests partly against the temperature control plate and partly against the main housing; and
the fixing wedge is connected to the main housing by a material bond.

11. The housing according to claim 2,
wherein at least one fixing wedge is arranged between two longitudinal webs of at least one guide device with respect to the housing upward direction.

12. An energy storage system for a vehicle, comprising:
a housing according to claim 1; and
a plurality of energy storage cells arranged in the housing interior;
wherein the energy storage cells are arranged on the temperature control plate for temperature control.

13. A temperature control plate for a housing and/or an energy storage device, comprising:
a connection side and a deflection side spaced from the connection side; and
at least one fluid channel arrangement which has a forward channel and a return channel for guiding a temperature control fluid through the temperature control plate;
wherein the forward channel and the return channel are spaced apart from one another and each pass completely through the temperature control plate from the connection side to the deflection side; and
wherein the temperature control plate is formed on the deflection side such that, together with a deflection cover formed separately from the temperature control plate, a fluidic connection can be formed between the forward channel and the return channel on the deflection side.

14. The temperature control plate according to claim 13, wherein:
the temperature control plate is formed at least partially or in sections or completely as an extrusion profile; and/or
the temperature control plate is formed at least partially or in sections or completely as a metallic extrusion profile; and/or
the at least one fluid channel arrangement or all fluid channel arrangements of the temperature control plate are formed as extrusion cavities.

15. A method of manufacturing an energy storage device, comprising:
providing a temperature control plate;
fixing a plurality of energy storage cells to the temperature control plate; and
inserting the temperature control plate with the energy storage cells fixed thereto into a housing interior of a main housing of a housing, so that the energy storage cells are positioned within the housing interior of the main housing; and
positioning the temperature control plate such that displacement of the temperature control plate with respect to the main housing is prevented.

16. The method according to claim 15, wherein the temperature control plate includes a connection side and a deflection side spaced from the connection side.

17. The method according to claim 15, wherein the temperature control plate includes at least one fluid channel arrangement which has a forward channel and a return channel for guiding a temperature control fluid through the temperature control plate.

18. The method according to claim 17, wherein the forward channel and the return channel are spaced apart from one another and each pass completely through the temperature control plate from a connection side to a deflection side.

19. The method according to claim 18, wherein the temperature control plate is formed on the deflection side such that, together with a deflection cover formed separately from the temperature control plate, a fluidic connection can be formed between the forward channel and the return channel on the deflection side.

20. The method according to claim 15, wherein:
the temperature control plate is formed at least partially or in sections or completely as an extrusion profile; and/or
the temperature control plate is formed at least partially or in sections or completely as a metallic extrusion profile; and/or
at least one fluid channel arrangement or all fluid channel arrangements of the temperature control plate are formed as extrusion cavities.
